(19) United States
(12) Patent Application Publication
(10) Pub. No.: US 2024/0235132 A9
(43) Pub. Date: Jul. 11, 2024

(54) CABLE CONNECTION HAVING IMPROVED ELECTROMAGNETIC SHIELDING

(71) Applicant: Valeo eAutomotive Germany GmbH, Erlangen (DE)

(72) Inventors: Guido RASEK, Erlangen (DE); Madhavi DHARA, Erlangen (DE)

(73) Assignee: Valeo eAutomotive Germany GmbH, Erlangen (DE)

(21) Appl. No.: 18/546,561

(22) PCT Filed: Oct. 28, 2021
(86) PCT No.: PCT/EP2021/079915

§ 371 Date: Aug. 15, 2023

(30) Foreign Application Priority Data
Feb. 22, 2021 (DE) 10 2021 201 644.8

(51) Int. Cl. H01R 24/30; B60R 16/02

(52) U.S. Cl. CPC H01R 24/30; B60R 16/0215; H02K 5/225

(57) ABSTRACT

A device in a motor vehicle includes two electric and/or electronic assemblies and a cable connection. The electric and/or electronic assemblies are electrically connected via the allocated terminals to at least two earth lines and at least two current-carrying lines of the cable connection. The cable connection has, for each current carrying line, at least one earth line which extends along the current-carrying line and in the same longitudinal direction as the current-carrying line. Also specified are an electric drive in a motor vehicle having such a device, and a motor vehicle having such a drive.

### TECHNICAL FIELD

The invention relates to a device in a motor vehicle, an electric drive in a motor vehicle having such a device and a motor vehicle having such a drive.

### PRIOR ART

Cable connections between electrical and/or electronic assemblies emit electromagnetic fields which depend predominantly on the level of the voltages and currents in this cable connection and can have an influence on other electronic assemblies and also the human organism. This applies in particular to cable connections in the drive group of an electrically operated motor vehicle. The currents occurring there cause a very strong electromagnetic field, for which reason these cable connections are generally equipped with an electromagnetic shield.

For example, electrically conductive foils or braids which are connected to ground and thus largely prevent the emission of an electromagnetic field are provided around current-carrying conductors. Effective electromagnetic shielding, not least owing to the in any case already large cross sections of the current-carrying conductors, result in rigid and inflexible cables which can be laid only with difficulty in particular in the confined conditions of a motor vehicle. Narrow bending radii are in this case not possible. In addition, such cables are expensive and are often not installed owing to the prevailing price pressure.

DE 10 2018 220 420 A1 also discloses for this purpose a circuit device for magnetic field compensation of electrical supply lines having at least two supply lines for the electrical connection of second electrical components. The circuit device comprises an additional line for carrying the reverse currents induced by the supply lines and for attenuating the magnetic field emitted from the supply lines. The additional line is arranged next to the at least first and second supply line and is connected to the connections to ground of the electrical components.

Although this arrangement results in more flexible cable connections, in many cases it has only an insufficient electromagnetic shielding. There is therefore lacking a cable connection which is flexible, has sufficient electromagnetic shielding, is not overly expensive and can be laid retrospectively, if appropriate.

### DISCLOSURE OF THE INVENTION

One object of the invention therefore consists in specifying an improved device in a motor vehicle, an improved electric drive and an improved motor vehicle. In particular, the intention is to specify a cable connection which is flexible, has sufficient electromagnetic shielding, is not overly expensive and can be laid retrospectively, if appropriate.

The object of the invention is achieved with a device in a motor vehicle, comprising
two electrical and/or electronic assemblies which each have a connection to ground for at least two ground conductors and terminals for at least two current-carrying conductors, and
a cable connection having at least two ground conductors and at least two current-carrying conductors,
wherein the electrical and/or electronic assemblies are electrically connected to the at least two ground conductors and the at least two current-carrying conductors of the cable connection via the associated terminals, and
wherein the cable connection has, per current-carrying conductor, at least one associated ground conductor which runs along the current-carrying conductor and in the same longitudinal direction as the current-carrying conductor (i.e. “parallel” thereto).

The object of the invention is also achieved by an electric drive in a motor vehicle which comprises a device of the abovementioned type, wherein the electrical and/or electronic assemblies comprise a voltage source and an inverter which is electrically connected to the voltage source and an electric machine which is electrically connected to the inverter.

Finally, the invention is achieved by a motor vehicle having at least two axles, wherein at least one of the axles is driven, and wherein said driving action takes place at least partially or for part of the time by means of the electric machine of the electric drive of the abovementioned type.

By virtue of the proposed measures, a cable connection results which is flexible and can therefore also be laid with narrow radii, has sufficient electromagnetic shielding which also shields the strong electromagnetic fields in a motor vehicle sufficiently well, is comparatively inexpensive and can also be laid retrospectively, if appropriate.

A “ground conductor” within the scope of this disclosure should be understood to mean a single electrical conductor. In particular, a “ground conductor” should not be understood to mean a wire mesh or wire fabric or else a metallic foil around a current-carrying conductor.

The term “current-carrying” means that a useful current is flowing in the relevant electrical conductor during operation. Although a current can also flow in the ground conductor, it is not primarily used for the operation of the electrical and/or electronic assemblies, but is a consequence of its shielding function.

In particular, in a DC voltage power supply system and in an AC power supply system two current-carrying conductors can be provided, and in an AC power supply system three or more current-carrying conductors can also be provided. Consequently, at least two ground conductors or at least three ground conductors can be provided.

The voltage source can be in the form of a battery or rechargeable battery or else in the form of a fuel cell. An embodiment in the form of a generator in combination with an internal combustion engine (for example in the form of a range extender) would also be possible. The electric machine can be in the form of, in particular, a synchronous machine or an asynchronous machine. The cable connection can be embodied in particular with two poles, i.e. with two current-carrying conductors, between a DC voltage source and the inverter. The cable connection can be embodied in particular with three or more poles, i.e. with three or more current-carrying conductors, between the inverter and an AC machine. Consequently, in turn at least two ground conductors or at least three ground conductors can be provided.

Further advantageous configurations and developments of the invention can be gleaned from the dependent claims and the description when considered in conjunction with the figures.

It is favorable if the cable connection has, per current-carrying conductor, precisely one ground conductor which runs along the current-carrying conductor and in the same longitudinal direction as the current-carrying conductor or “parallel” to the current-carrying conductor. As a result, the cable connection can be produced easily and is also particularly flexible, i.e. narrow radii are possible when laying the cable.

It is favorable furthermore if the cable connection comprises an insulation for a current-carrying conductor of the current-carrying conductors, and the at least one ground conductor assigned to the current-carrying conductor runs within this insulation. Advantageously, a preset spacing between the current-carrying conductor and the ground conductor is thus maintained independently of a specific way in which the cable is laid.

It is also favorable, however, if the cable connection comprises an insulation for a current-carrying conductor of the current-carrying conductors, and the at least one ground conductor assigned to the current-carrying conductor runs outside this insulation. Owing to the separation between the current-carrying conductor and the ground conductor, this type of cable connection is particularly flexible and can therefore be laid easily with narrow radii. In addition, a ground conductor can in this way also be added retrospectively to a current-carrying conductor, for example when it becomes apparent that shielding of the current-carrying conductors is necessary. The ground conductor in this embodiment variant can have a separate insulation, but can also be designed to be bare. A cable assembly can be produced, for example, by virtue of the fact that a ground conductor is fastened to the insulated current-carrying conductor with the aid of cable ties.

In a preferred variant, the device has a plug-type connection having plug-type contacts, wherein the at least two ground conductors and the current-carrying conductors are connected to at least one of the electrical and/or electronic assemblies with the aid of the plug-type contacts. By virtue of the proposed measures, the cable connection can be electrically connected to the voltage source in a simple manner. That part of the plug-type connection which is fixedly connected to the current-carrying conductors and/or the ground conductors can be in the form of a male connector or a female connector. The assembly-side part of the plug-type connection is then consequently in the form of a female connector or a male connector in inverted fashion.

It is also advantageous if the device has a plug-type connection having plug-type contacts, wherein the current-carrying conductors are connected to at least one of the electrical and/or electronic assemblies with the aid of the plug-type contacts, and wherein a part of the plug-type connection which is fixedly connected to the current-carrying conductors and is insulated from the plug-type contacts has a terminal for the at least two ground conductors via which the at least two ground conductors are connected to the connection to ground of the at least one electrical and/or electronic unit/assembly. That part of the plug-type connection which is fixedly connected to the current-carrying conductors and is insulated from the plug-type contacts can be in particular a housing of the plug-type connection. This housing can be produced from a metal, for example, and the at least two ground conductors can be embedded directly in the male connector housing and can be conductively connected to the connection to ground of the electrical and/or electronic assemblies in such a way. For the electrical insulation of the current-carrying conductors, female insulation connectors can also be embedded in the male connector housing. It is in particular also conceivable for the ground conductors to be screwed or pressed to the male connector housing. The housing of the electrical and/or electronic assemblies can be produced from an insulator or from a metal. That part of the plug-type connection which is fixedly connected to the current-carrying conductors can in turn be in the form of a male connector or a female connector, and the assembly-side part of the plug-type connection is then consequently again in the form of a female connector or a male connector in inverted fashion.

Finally, also advantageous is a device having a plug-type connection having plug-type contacts, wherein the current-carrying conductors are connected to at least one of the electrical and/or electronic assemblies with the aid of the plug-type contacts, and wherein the plug-type connection is secured against being unintentionally released with the aid of a screw-type connection which is insulated from the plug-type contacts, and the at least two ground conductors are connected to the connection to ground of the at least one electrical and/or electronic unit/assembly via this screw-type connection. For example, the at least two ground conductors can be clamped with screws of the screw-type connection for this purpose. The electrical connection between the at least two ground conductors and the connection to ground of the electrical and/or electronic assembly can take place via the screws of the screw-type connection if they are manufactured from metal. It would also be conceivable, however, to manufacture the male connector housing from metal and to produce the electrical connection between the ground conductor and the connection to ground in this way. The at least two ground conductors can be connected to a shield of the electrical and/or electronic assembly via the screws or the male connector housing. The shield can also be formed directly by the housing of the electrical and/or electronic assembly if it is manufactured from a metal.

The above configurations and developments of the invention can be combined in any desired way.

### BRIEF DESCRIPTION OF THE FIGURES

Exemplary embodiments of the invention are illustrated by way of example in the appended schematic figures. In the figures:

FIG. 1 shows a schematic illustration of a device in a motor vehicle having electrical and/or electronic assemblies and cable connections therebetween;

FIG. 2 shows a cable connection having an insulated current-carrying conductor and a separate insulated ground conductor in section;

FIG. 3 shows a cable connection having an insulated current-carrying conductor and a separate uninsulated ground conductor in section;

FIG. 4 shows a cable connection having a current-carrying conductor and a ground conductor in a common insulation in section;

FIG. 5 shows a plug-type connection having plug-type contacts for connecting the current-carrying conductors and the ground conductors to a voltage source in section;

FIG. 6 is similar to FIG. 5, but with a connection to ground via the male connector housing; and

FIG. 7 shows a plug-type connection in which the ground conductor is clamped to a screw-type connection for securing the plug-type connection.

### DETAILED DESCRIPTION OF THE INVENTION

It will be mentioned by way of introduction that identical parts in the different embodiments are provided with the same reference signs or the same component designations, with different indices where appropriate. The disclosures of a component contained in the description may accordingly be transferred to another component with the same reference sign or the same component designation. Also, the positional indications selected in the description, such as, for example, “top”, “bottom”, “rear”, “front”, “side” etc. relate to the figure directly described and illustrated and, in the event of a change in position, should be transferred accordingly to the new position.

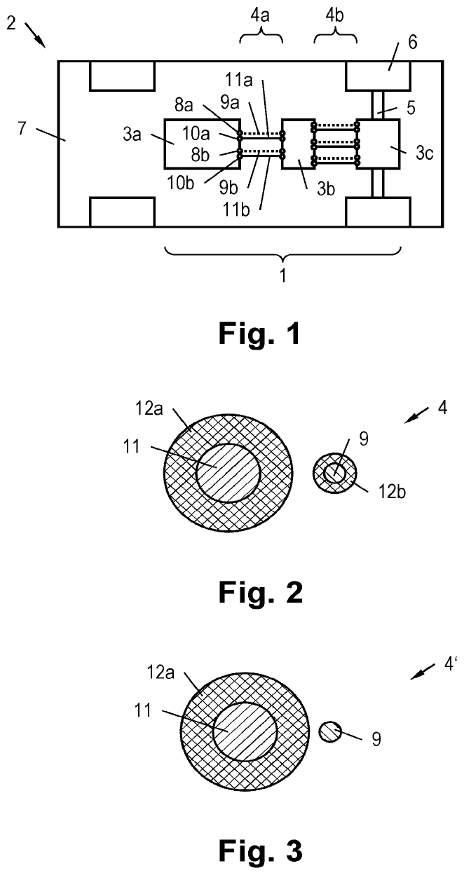

FIG. 1 shows a schematic illustration of a device 1 in a motor vehicle 2 which comprises a plurality of electrical and/or electronic assemblies 3a . . . 3c and cable connections 4a, 4b to which the electrical and/or electronic assemblies 3a . . . 3c are electrically connected. Specifically, the electrical and/or electronic assemblies in the present example are in the form of voltage source 3a, inverter 3b and electric machine 3c.

The voltage source 3a can be in the form of a battery or rechargeable battery or else in the form of a fuel cell. An embodiment in the form of a generator in combination with an internal combustion engine (for example in the form of a range extender) would also be possible. The electric machine 3c can be in the form of, in particular, a synchronous machine or an asynchronous machine. A DC voltage produced by the voltage source 3a is converted by the inverter 3b into an AC voltage which drives the electric machine 3c and therefore, via the half-axles 5, the wheels 6 of the motor vehicle 2 which are mounted in rotatable fashion on the frame 7 of the motor vehicle 2.

The electrical and/or electronic assemblies 3a . . . 3c each have a connection to ground 8a, 8b for at least two ground conductors 9a, 9b of the cable connections 4a, 4b and terminals 10a, 10b for at least two current-carrying conductors 11a, 11b of the cable connections 4a, 4b. Correspondingly, the cable connections 4a, 4b each have at least two ground conductors 9a, 9b, which are illustrated by dashed lines in FIG. 1, and at least two current-carrying conductors 11a, 11b, which are illustrated by continuous lines in FIG. 1. The electrical and/or electronic assembly 3a is connected to the ground conductors 9a, 9b via the connections to ground 8a, 8b and to the current-carrying conductors 11a, 11b via the terminals 10a, 10b.

Specifically, the cable connection 4a, 4b comprises, per current-carrying conductor 11a, 11b, at least one ground conductor 9a, 9b which runs along the current-carrying conductor 11a, 11b and in the same longitudinal direction as the current-carrying conductor 11a, 11b (i.e. “parallel” thereto). Especially, per current-carrying conductor 11a, 11b, precisely one ground conductor 9a, 9b can be provided which runs along the current-carrying conductor 11a, 11b and in the same longitudinal direction as the current-carrying conductor 11a, 11b.

A ground conductor 9a, 9b should generally be understood to mean a single electrical conductor. In particular, it does not form a wire mesh or wire fabric around a current-carrying conductor 11a, 11b. In general, there is also no useful current flowing in the ground conductor 9a, 9b but at most a current which is a consequence of its shielding function but is not used primarily for the operation of the electrical and/or electronic assemblies 3a . . . 3c.

At this juncture it will be noted that the terminals of the inverter 3b, the electric machine 3c and the cable connection 4b are not explicitly designated, for reasons of improved illustration, but are present in an equivalent manner.

Between the voltage source 3a and the inverter 3b, the cable connection 4a can in particular be embodied with two poles, i.e. with two current-carrying conductors 11a, 11b, and between the inverter 3b and the electric machine 3c, the cable connection 4b can in particular be embodied with three or more poles, i.e. with three or more current-carrying conductors 11a, 11b, as is illustrated by way of example in FIG. 1.

FIG. 2 shows an example in which the cable connection 4 comprises an insulation 12a for a current-carrying conductor 11 and the at least one ground conductor 9 assigned to the current-carrying conductor 11 runs outside this insulation 12a. In this example, the ground conductor 9 has a separate insulation 12b. It would also be conceivable, however, for the ground conductor 9 to be laid without dedicated insulation 12b, as is illustrated for the cable connection 4′ in FIG. 3.

In both cases, a ground conductor 9 can be laid retrospectively, for example when it becomes apparent that a shielding of the current-carrying conductor 11 is necessary. It is also advantageous that the cable connection 4, 4′ is flexible owing to the current-carrying conductors 11 and ground conductors 9, which are separated from one another, and can therefore be laid well even with narrow radii.

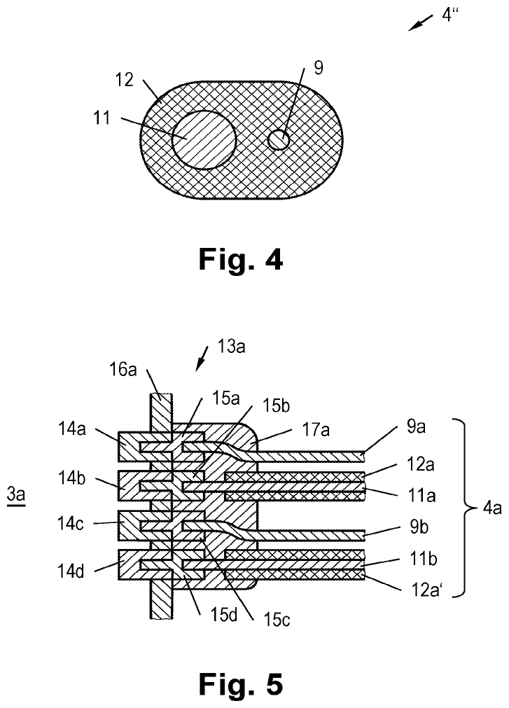

FIG. 4 shows an alternative embodiment of a cable connection 4″ which in turn comprises an insulation 12 for the current-carrying conductor 11 in which the at least one ground conductor 9 assigned to the current-carrying conductor 11 runs inside this insulation 12, however. Advantageously, a preset spacing between the current-carrying conductor 11 and the ground conductor 9 is thus maintained independently of a specific way in which the cable is laid.

FIG. 5 shows an example of a plug-type connection 13a having plug-type contacts 14a . . . 14d, 15a . . . 15d, wherein the ground conductors 9a, 9b and current-carrying conductors 11a, 11b are connected to at least one of the electrical and/or electronic assemblies 3a . . . 3c with the aid of the plug-type contacts 14a . . . 14d, 15a . . . 15d. Specifically, FIG. 5 shows a detail of the voltage source 3a which has a plurality of plug-type contacts in the form of female connectors 14a . . . 14d which are arranged in a voltage source housing 16a of the voltage source 3a. The female connectors 14a, 14c in this case form connections to ground 8a, 8b of the voltage source 3a, while the female connectors 14b, 14d form terminals 10a, 10b for the current-carrying conductors 11a, 11b. The female connectors 14a . . . 14d are wired within the voltage source 3a, which is not explicitly illustrated in FIG. 5, however.

Furthermore, plug-type contacts in the form of male connectors 15a . . . 15d which are embedded in a male connector housing 17a are illustrated in FIG. 5. The ground conductors 9a, 9a are in this case fixedly connected to the male connectors 15a, 15c, and the current-carrying conductors 11a, 11b are fixedly connected to the male connectors 15b, 15d. The male connectors 15a . . . 15d are plugged releasably into the female connectors 14a . . . 14d. Furthermore, the current-carrying conductors 11a, 11b each comprise an insulation 12a, 12a′. The voltage source housing 16a and the male connector housing 17a are in this case likewise produced from an insulator.

By virtue of the proposed measures, the cable connection 4a can be electrically connected to the voltage source 3a in a simple manner.

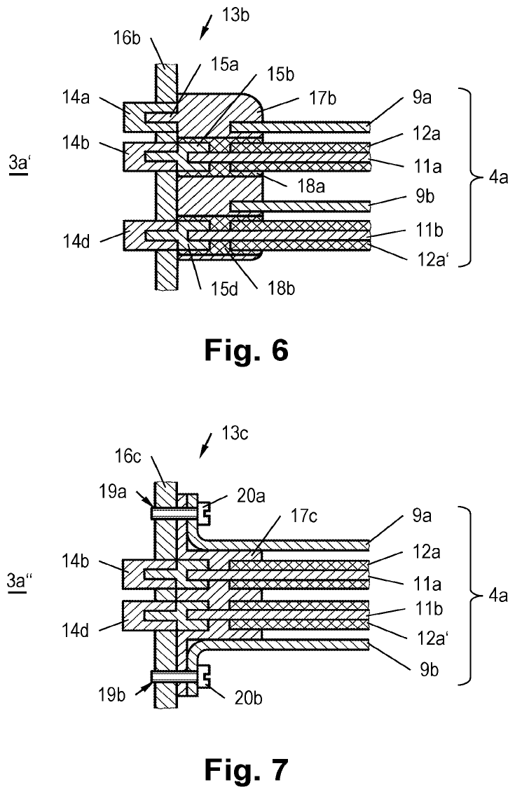

Also conceivable, however, is an alternative embodiment, illustrated in FIG. 6, of a plug-type connection 13b which is similar to the plug-type connection 13a illustrated in FIG. 5. However, a part of the plug-type connection 13b which is fixedly connected to the current-carrying conductors 11a, 11b and insulated from the plug-type contacts 14b, 14d has terminals for the ground conductors 9a, 9b via which they are connected to the connection to ground 8a, 8b of the voltage source 3a′. Specifically, that part of the plug-type connection 13b which is insulated from the plug-type contacts 11a, 11b is in the form of a male connector housing 17b. This is produced in this example from a metal and has directly a male connector 15a which has been plugged into the female connector 14a. The ground conductors 9a, 9b are embedded directly in the male connector housing 17b and are conductively connected to the connection to ground 8a, formed by the female connector 14a, of the voltage source 3a′ in this way. For the electrical insulation of the current-carrying conductors 11a, 11b, female insulation connectors 18a, 18b are also embedded in the male connector housing 17b. It is in particular also conceivable for the ground conductors 9a, 9b to be screwed or pressed to the male connector housing 17b. The voltage source housing 16b can be produced from an insulator or from a metal. If it is manufactured from a metal, a separate female connector 14a can also be dispensed with.

FIG. 7 shows a further, alternative embodiment of a plug-type connection 13c which is similar to the plug-type connection 13a illustrated in FIG. 5. However, the plug-type connection 13c is in this case secured against unintentional release with the aid of a screw-type connection 19a, 19b which is insulated from the plug-type contacts 14b, 14d, and the ground conductors 9a, 9b are connected to the connection to ground 8a, 8b of the voltage source 3a″ via this screw-type connection 19a, 19b. Specifically, the ground conductors 9a, 9b are clamped and conductively connected to the male connector housing 17c by the screws 20a, 20b of the screw-type connection 19a, 19b. The voltage source housing 16c in this example is manufactured from metal, while the male connector housing 17c is manufactured from an insulator. The electrical connection between the ground conductors 9a, 9b and the voltage source housing 16c takes place via the metallic screws 20a, 20b. It would also be conceivable, however, for the male connector housing 17c to be manufactured from metal if corresponding female insulation connectors 18a, 18b are provided (see in this regard FIG. 6).

Finally, it will be mentioned that the scope of protection is determined by the patent claims. The description and the drawings should however serve as reference for interpretation of the claims. The features contained in the figures may be interchanged and combined with one another as desired. In particular, it will also be mentioned that the devices illustrated may in reality also comprise more or else fewer component parts than illustrated. In some cases, the illustrated devices or their component parts may also be illustrated not to scale and/or on an enlarged scale and/or on a reduced scale.

1. A device in a motor vehicle, comprising
two electrical and/or electronic assemblies which each have a connection to ground for at least two ground conductors and terminals for at least two current-carrying conductors, and
a cable connection having at least two ground conductors and at least two current-carrying conductors,
wherein the electrical and/or electronic assemblies are electrically connected to the at least two ground conductors and the at least two current-carrying conductors of the cable connection via the associated terminals, and
wherein the cable connection has, per current-carrying conductor, at least one assigned ground conductor which runs along the current-carrying conductor and in the same longitudinal direction as the current-carrying conductor.

2. The device as claimed in claim 1, wherein the cable connection has, per current-carrying conductor, precisely one ground conductor which runs along the current-carrying conductor and in the same longitudinal direction as the current-carrying conductor.

3. The device as claimed in claim 1, wherein, the cable connection comprises an insulation for a current-carrying conductor of the current-carrying conductors, and the at least one ground conductor assigned to the current-carrying conductor runs within this insulation.

4. The device as claimed in claim 1, wherein the cable connection comprises an insulation for a current-carrying conductor of the current-carrying conductors, and the at least one ground conductor assigned to the current-carrying conductor runs outside this insulation.

5. The device as claimed in claim 1, wherein a plug-type connection having plug-type contacts, wherein the at least two ground conductors and the current-carrying conductors are connected to at least one of the electrical and/or electronic assemblies with the aid of the plug-type contacts.

6. The device as claimed in claim 1, wherein a plug-type connection having plug-type contacts, wherein the current-carrying conductors are connected to at least one of the electrical and/or electronic assemblies with the aid of the plug-type contacts, and wherein a part of the plug-type connection which is fixedly connected to the current-carrying conductors and is insulated from the plug-type contacts has a terminal for the at least two ground conductors via which the at least two ground conductors are connected to the connection to ground of the at least one electrical and/or electronic unit/assembly.

7. The device as claimed in claim 6, wherein that part of the plug-type connection which is fixedly connected and is insulated from the plug-type contacts comprises a metallic male connector housing, and the at least two ground conductors for the electrical connection to the connection to ground of the at least one electrical and/or electronic unit/assembly
are embedded directly in the male connector housing or
are screwed or pressed to the male connector housing.

8. The device as claimed in claim 1, wherein a plug-type connection having plug-type contacts, wherein the current-carrying conductors are connected to at least one of the electrical and/or electronic assemblies with the aid of the plug-type contacts, and wherein the plug-type connection is secured against being unintentionally released with the aid of a screw-type connection which is insulated from the plug-type contacts, and the at least two ground conductors are connected to the connection to ground of the at least one electrical and/or electronic unit/assembly via this screw-type connection.

9. An electric drive in a motor vehicle, wherein the device as claimed in claim 1, wherein the electrical and/or electronic assemblies comprise a voltage source and an inverter which is electrically connected to the voltage source and comprise an electric machine which is electrically connected to the inverter.

10. A motor vehicle having at least two axles, at least one of which is driven, wherein said driving action takes place at least partially or for part of the time by means of the electric machine of the electric drive as claimed in claim 9.

11. The device as claimed in claim 2, wherein the cable connection comprises an insulation for a current-carrying conductor of the current-carrying conductors, and the at least one ground conductor assigned to the current-carrying conductor runs within this insulation.

12. The device as claimed in claim 2, wherein the cable connection comprises an insulation for a current-carrying conductor of the current-carrying conductors, and the at least one ground conductor assigned to the current-carrying conductor runs outside this insulation.

13. The device as claimed in claim 2, wherein a plug-type connection having plug-type contacts, wherein the at least two ground conductors and the current-carrying conductors are connected to at least one of the electrical and/or electronic assemblies with the aid of the plug-type contacts.

14. The device as claimed in claim 2, wherein a plug-type connection having plug-type contacts, wherein the current-carrying conductors are connected to at least one of the electrical and/or electronic assemblies with the aid of the plug-type contacts, and wherein a part of the plug-type connection which is fixedly connected to the current-carrying conductors and is insulated from the plug-type contacts has a terminal for the at least two ground conductors via which the at least two ground conductors are connected to the connection to ground of the at least one electrical and/or electronic unit/assembly.

15. The device as claimed in claim 2, wherein a plug-type connection having plug-type contacts, wherein the current-carrying conductors are connected to at least one of the electrical and/or electronic assemblies with the aid of the plug-type contacts, and wherein the plug-type connection is secured against being unintentionally released with the aid of a screw-type connection which is insulated from the plug-type contacts, and the at least two ground conductors are connected to the connection to ground of the at least one electrical and/or electronic unit/assembly via this screw-type connection.

16. An electric drive in a motor vehicle, wherein the device as claimed in claim 2, wherein the electrical and/or electronic assemblies comprise a voltage source and an inverter which is electrically connected to the voltage source and comprise an electric machine which is electrically connected to the inverter.

17. The device as claimed in claim 3, wherein a plug-type connection having plug-type contacts, wherein the at least two ground conductors and the current-carrying conductors are connected to at least one of the electrical and/or electronic assemblies with the aid of the plug-type contacts.

18. The device as claimed in claim 3, wherein a plug-type connection having plug-type contacts, wherein the current-carrying conductors are connected to at least one of the electrical and/or electronic assemblies with the aid of the plug-type contacts, and wherein a part of the plug-type connection which is fixedly connected to the current-carrying conductors and is insulated from the plug-type contacts has a terminal for the at least two ground conductors via which the at least two ground conductors are connected to the connection to ground of the at least one electrical and/or electronic unit/assembly.

19. The device as claimed in claim 3, wherein a plug-type connection having plug-type contacts, wherein the current-carrying conductors are connected to at least one of the electrical and/or electronic assemblies with the aid of the plug-type contacts, and wherein the plug-type connection is secured against being unintentionally released with the aid of a screw-type connection which is insulated from the plug-type contacts, and the at least two ground conductors are connected to the connection to ground of the at least one electrical and/or electronic unit/assembly via this screw-type connection.

20. An electric drive in a motor vehicle, wherein the device as claimed in claim 3, wherein the electrical and/or electronic assemblies comprise a voltage source and an inverter which is electrically connected to the voltage source and comprise an electric machine which is electrically connected to the inverter.
